(19) United States
(12) Patent Application Publication
(10) Pub. No.: US 2025/0194679 A1
(43) Pub. Date: Jun. 19, 2025

(54) ELECTRONIC CIGARETTE

(71) Applicant: YIBLA (USA) TECHNOLOGY CO., LTD, City of Industry, CA (US)

(72) Inventor: GUANGRUI WANG, Puyang (CN)

(21) Appl. No.: 18/539,460

(22) Filed: Dec. 14, 2023

(51) Int. Cl. A24F 40/46; A24F 40/10; A24F 40/42; A24F 40/44; A24F 40/48; A24F 40/51; A24F 40/60; H05B 3/22

(52) U.S. Cl. CPC A24F 40/46; A24F 40/10; A24F 40/42; A24F 40/44; A24F 40/48; A24F 40/51; A24F 40/60; H05B 3/22

(57) ABSTRACT

The present disclosure relates to an electronic cigarette, including a housing, a cigarette holder, a liquid storage component, a porous liquid suction component, a first atomization assembly, and a second atomization assembly, where the housing is provided with a first accommodating cavity, the liquid storage component is located in the first accommodating cavity, and a second accommodating cavity is provided in the liquid storage component. The porous liquid suction component is located in the second accommodating cavity and provided with a first atomizing cavity and a second atomizing cavity. The first atomization assembly includes a first heating element and a second heating element located at different positions in the first atomizing cavity, respectively. The second atomization assembly includes a third heating element located in the second atomizing cavity. The present disclosure implements sufficient liquid supply during operation, avoids the problem of dry burning due to insufficient liquid supply.

### TECHNICAL FIELD

The present disclosure relates to the technical field of electronic cigarettes, and more specifically, to an electronic cigarette.

### BACKGROUND

With the development of society, people attach increasing importance to health. One of the important factors for harm of cigarettes to physical health is the production of harmful substances during tobacco burning, and the cigarettes are easily addictive and difficult to quit, so in order to avoid the harm of the cigarettes to the physical health, those skilled in the art have developed electronic cigarettes, which have a similar taste to the cigarettes and avoid the problem in inhaling the harmful substances during cigarette burning.

In an existing electronic cigarette, a single heating element is generally used to heat and atomize atomizing liquid. The design of the single heating element results in a small amount of smoke in the electronic cigarette, which cannot meet the smoking requirement of a user for a large amount of smoke. In order to solve the above technical problem, those skilled in the art have developed an electronic cigarette with a plurality of heating elements. However, in the existing electronic cigarette with a plurality of heating elements, insufficient supply of atomizing liquid is easily caused during operation due to unreasonable layout of the heating elements.

### SUMMARY

An objective of the present disclosure is to provide an electronic cigarette capable of implementing sufficient supply of atomizing liquid during operation.

To solve the above problem, the present disclosure adopts the following solution: an electronic cigarette is constructed, including a housing, a cigarette holder, a liquid storage component, a porous liquid suction component, a first atomization assembly, and a second atomization assembly, where the housing is provided with a first accommodating cavity, and the cigarette holder is connected to the housing; the liquid storage component is located in the first accommodating cavity, and a second accommodating cavity is provided in the liquid storage component; the porous liquid suction component is located in the second accommodating cavity and provided with a first atomizing cavity and a second atomizing cavity that both communicate with the cigarette holder, and the first atomizing cavity is arranged in parallel to the second atomizing cavity;

a distance between the first atomizing cavity and a first side surface of the porous liquid suction component is greater than a distance between the second atomizing cavity and a second side surface of the porous liquid suction component, and the first side surface of the porous liquid suction component is arranged opposite to the second side surface of the porous liquid suction component; the first atomization assembly includes a first heating element and a second heating element located at different positions in the first atomizing cavity, respectively; and the second atomization assembly includes a third heating element located in the second atomizing cavity.

The present disclosure has the following beneficial effects: according to the present disclosure, the porous liquid suction component is provided with the first atomizing cavity and the second atomizing cavity, the distance between the first atomizing cavity and the first side surface of the porous liquid suction component is greater than the distance between the second atomizing cavity and the second side surface of the porous liquid suction component, and the first side surface of the porous liquid suction component is arranged opposite to the second side surface of the porous liquid suction component. The first atomization assembly includes the first heating element and the second heating element located at the different positions in the first atomizing cavity, respectively. The second atomization assembly includes the third heating element located in the second atomizing cavity. Therefore, through the ingenious matching arrangement, sufficient atomizing liquid is provided around the first atomization assembly and the second atomization assembly, such that sufficient liquid supply is ensured during operation, and the problem of dry burning caused by insufficient liquid supply is avoided.

### BRIEF DESCRIPTION OF DRAWINGS

The present disclosure is described below in conjunction with the accompanying drawings, in which:

FIG. 1 is a three-dimensional view of an embodiment of an electronic cigarette according to the present disclosure;

FIG. 2 is a sectional view of the electronic cigarette shown in FIG. 1;

FIG. 3 is an exploded view of the electronic cigarette shown in FIG. 1;

FIG. 4 is a three-dimensional view of a cigarette holder of the electronic cigarette shown in FIG. 1;

FIG. 5 is a three-dimensional view of an elastic sealing top cover of the electronic cigarette shown in FIG. 1;

FIG. 6 is a three-dimensional view of a fixing bracket of the electronic cigarette shown in FIG. 1; and

FIG. 7 is a sectional view of another embodiment of an electronic cigarette according to the present disclosure.

### DETAILED DESCRIPTION

The present disclosure is described in detail below with reference to the accompanying drawings and specific embodiments.

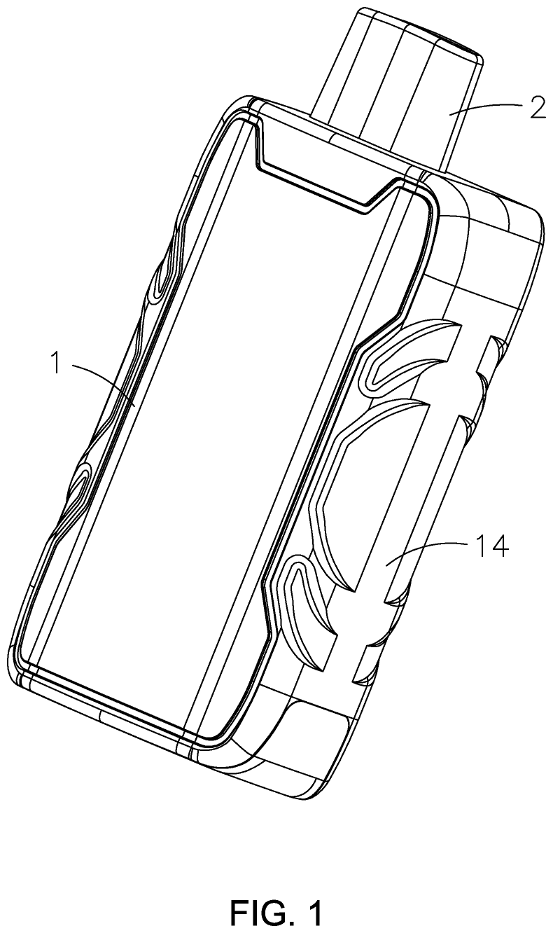

Referring to FIG. 1 to FIG. 3, the present disclosure provides an electronic cigarette, including a housing 1, a cigarette holder 2, a liquid storage component 3, a porous liquid suction component 4, a first atomization assembly 5, a second atomization assembly 6, a lamp panel 7, and a light source 8, where the housing 1 includes an outer sleeve 11 and a bottom cover 12, and the bottom cover 12 has a first end detachably inserted into and connected to the outer sleeve 11 and a second end located outside the outer sleeve 11. Limit steps 121 are formed at an end surface of the first end of the bottom cover 12, and limit bulges 122 are arranged at the limit steps 121. Fastening bulges 123 are arranged at an inner wall of the bottom cover 12.

The outer sleeve 11 and the bottom cover 12 form a first accommodating cavity 13, and a light-transmitting area 14 is arranged at a cavity wall of the first accommodating cavity 13 and contains a fluorescent material. Therefore, it is convenient for light in the first accommodating cavity 13 to be emitted from the light-transmitting area 14, so as to be used by a user in a dark environment. In an embodiment, the bottom cover 12 has a plate-like structure and is arranged at a bottom surface of the outer sleeve 11 in a covering manner. Therefore, a shape and a structure of the housing 1 may be set as needed and are not specifically limited herein.

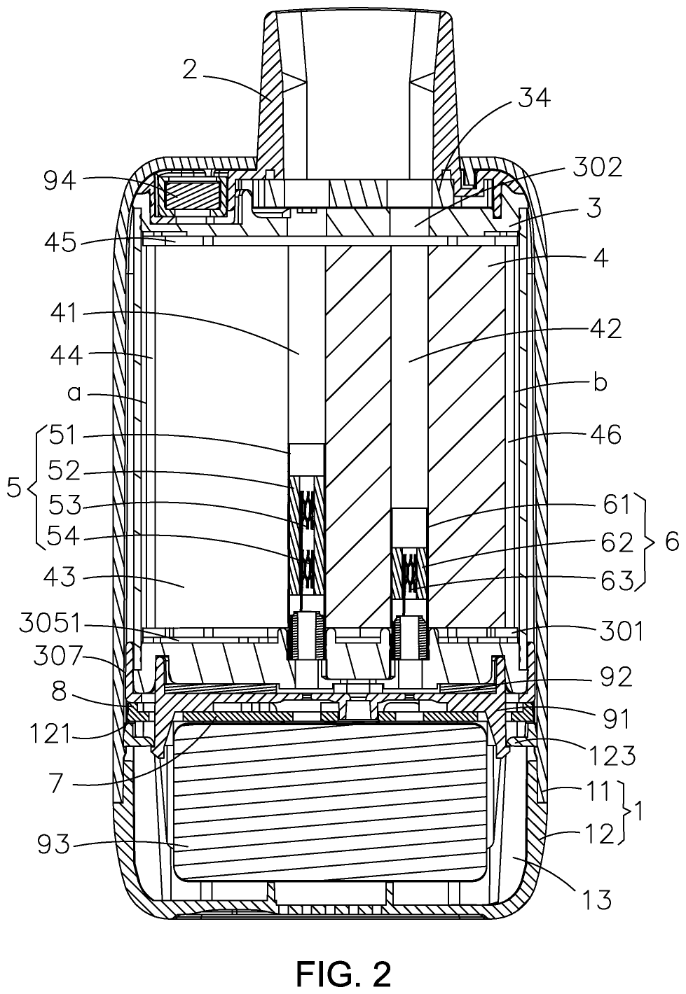

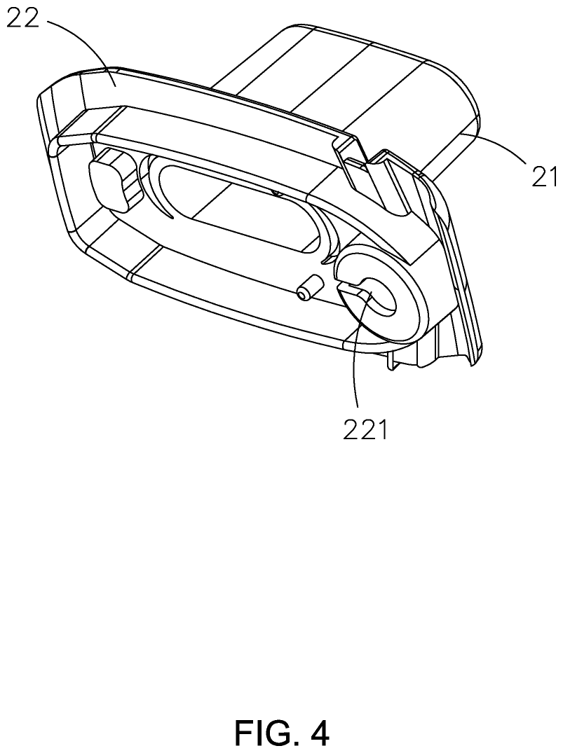

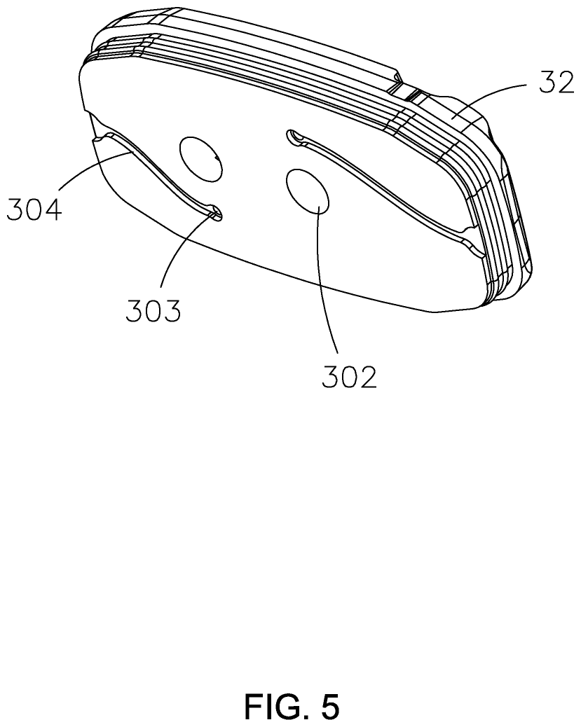

Referring to FIG. 2, FIG. 4, and FIG. 5, the cigarette holder 2 is connected to the housing 1 and includes a smoking part 21 and a connecting plate part 22 connected to the smoking part 21, where the smoking part 21 has a first end located outside the housing 1 and a second end penetrating through an end wall of the housing 1 and extending into the first accommodating cavity 13. The connecting plate part 22 is located in the first accommodating cavity 13 and arranged in a manner of extending along a transverse direction of the first accommodating cavity 13, such that the cigarette holder 2 is fastened and connected to the housing 1. A first accommodating groove 221 is provided in a surface of the connecting plate part 22 that is connected to the smoking part 21, and the liquid storage component 3 and the end wall of the housing 1 are clamped on the connecting plate part 22. Therefore, the reliability of fixing the cigarette holder 2 is enhanced. In an embodiment, the cigarette holder 2 and the housing 1 are of an integrally formed structure, such that a way of connection between the cigarette holder 2 and the housing 1 may be selected as needed.

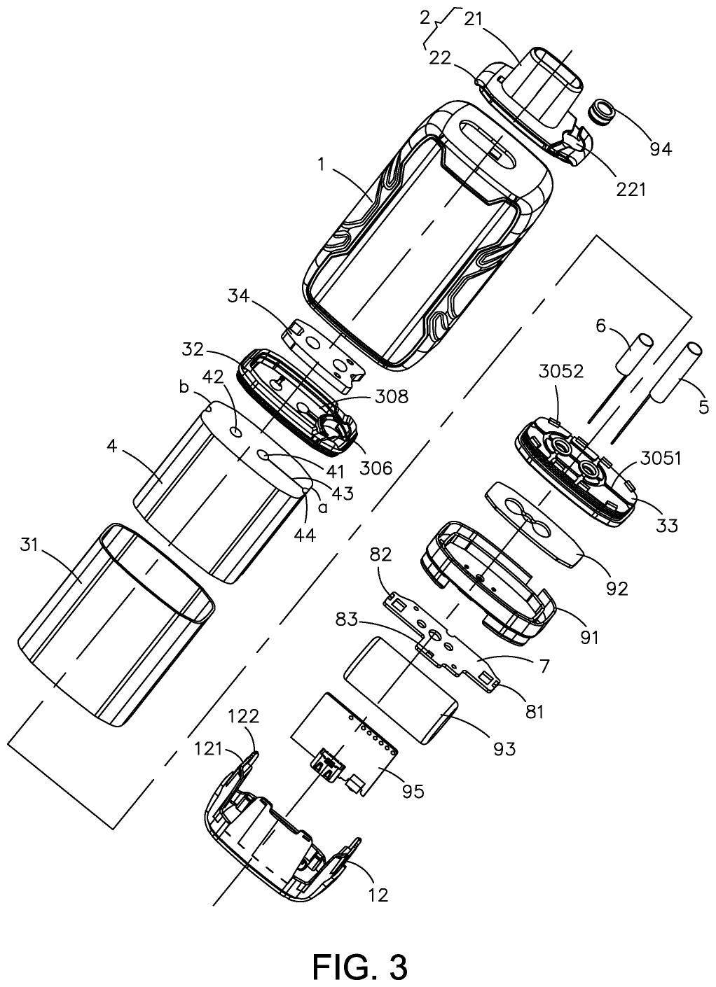

Referring to FIG. 2, FIG. 3, and FIG. 5, the liquid storage component 3 is located in the first accommodating cavity 13, a second accommodating cavity 301 is provided in the liquid storage component 3 and includes a first end wall and a second end wall arranged opposite to each other, the first end wall is located between the cigarette holder 2 and the second end wall, smoke discharge holes 302, an air guide hole 303, and a second air guide groove 304 that communicate with the cigarette holder 2 are provided in the first end wall, and the smoke discharge holes 302 are corresponding to the cigarette holder 2 in position. The air guide hole 303 has a first end communicating with the cigarette holder 2 and a second end communicating with the second air guide groove 304. The second air guide groove 304 is located in a surface of the first end wall that faces the porous liquid suction component 4. Therefore, when an external air pressure is low, air in the second accommodating cavity 301 can flow into the cigarette holder 2 through the second air guide groove 304 and the air guide hole 303, thereby better reducing the probability of atomizing liquid leakage.

A first air guide groove 3051 and blocking bulges 3052 are arranged on a surface of the second end wall that faces the porous liquid suction component 4, and the first air guide groove 3051 is arranged in a manner of transversely extending along a surface of a second end. There are a plurality of blocking bulges 3052, every two adjacent blocking bulges 3052 is arranged at an interval, and the plurality of blocking bulges 3052 are arranged along an edge of the surface of the second end wall that faces the porous liquid suction component 4 and form a ring shape. The porous liquid suction component 4 is blocked by the blocking bulges 3052, thereby better avoiding the problem that the first air guide groove 3051 is blocked when the porous liquid suction component 4 expands.

A second accommodating groove 306 is provided in a surface of the liquid storage component 3 that faces the connecting plate part 22, a groove wall of the first accommodating groove 221 extends into the second accommodating groove 306, and a groove wall of the second accommodating groove 306 is elastically sleeved with and connected to the groove wall of the first accommodating groove 221. Therefore, an outer wall of the first accommodating groove 221 is sealed with the second accommodating groove 306 of the liquid storage component 3, thereby better avoiding air leakage. An optical path transmission gap 307 is formed between the housing 1 and a side surface of the liquid storage component 3 and is configured to guide at least part of the light emitted by the light source 8 to the light-transmitting area 14, such that the light emitted from the light-transmitting area 14 is softer. Preferably, in an embodiment, the electronic cigarette further includes a light guide component located at the optical path transmission gap. Therefore, the light is farther transmitted and the emitted light is more uniform.

Specifically, the liquid storage component 3 is located in the outer sleeve 11 and includes an accommodating tube 31, an elastic sealing top cover 32, and an elastic sealing base 33, where the accommodating tube 31 is located in the first accommodating cavity 13, and the elastic sealing top cover 32 is detachably arranged at a first end of the accommodating tube 31 in a covering manner. The second accommodating groove 306 and a third accommodating groove 308 are provided in a surface of the elastic sealing top cover 32 that faces the connecting plate part 22, both the smoking part 21 and the smoke discharge hole 302 communicate with the third accommodating groove 308, and the second accommodating groove 306 communicates with the smoking part 21 through the third accommodating groove 308. A condensate adsorption sheet 34 is accommodated in the third accommodating groove 308 and configured to adsorb a condensate. The elastic sealing base 33 is arranged at a second end of the accommodating tube 31 in a covering manner, and the second accommodating cavity 301 is located in a space formed by the accommodating tube 31, the elastic sealing top cover 32, and the elastic sealing base 33. The elastic sealing top cover 32 and the elastic sealing base 33 may be made of a material such as silica gel or rubber. In an embodiment, the accommodating tube 31 and the elastic sealing top cover 32 are of an integrally formed structure.

The porous liquid suction component 4 is located in the second accommodating cavity 301 and provided with a first atomizing cavity 41 and a second atomizing cavity 42 arranged in parallel and both communicating with the cigarette holder 2, and the first atomizing cavity 41 and the second atomizing cavity 42 are spaced apart from each other and both extend to two opposite end surfaces of the porous liquid suction component 4. The third accommodating groove 308 communicates with the first atomizing cavity 41 and the second atomizing cavity 42 through the smoke discharge hole 302. Side surfaces of the porous liquid suction component 4 include a first side surface a and a second side surface b, the first side surface a of the porous liquid suction component 4 is arranged opposite to the second side surface b of the porous liquid suction component 4, the first atomizing cavity 41 is located between the first side surface a of the porous liquid suction component 4 and the second atomizing cavity 42, and a distance between the first atomizing cavity 41 and the first side surface a of the porous liquid suction component 4 is greater than a distance between the second atomizing cavity 42 and the second side surface b of the porous liquid suction component 4. Therefore, a volume of atomizing liquid between the first atomizing cavity 41 and the first side surface a of the porous liquid suction component 4 is greater than a volume of atomizing liquid between the second atomizing cavity 42 and the second side surface b of the porous liquid suction component 4, such that even if atomizing liquid in the first atomization assembly 5 is consumed too fast, it can be timely replenished to the first atomization assembly 5, thereby avoiding insufficient supply of the atomizing liquid in the first atomization assembly 5.

The porous liquid suction component 4 is further provided with an exhaust kerf 43, and the exhaust kerf 43 is located between the first side surface a of the porous liquid suction component 4 and the first atomizing cavity 41 and communicates with the first side surface a of the porous liquid suction component 4 and the first atomizing cavity 41. The first atomizing cavity 41 is located between the exhaust kerf 43 and the second atomizing cavity 42. A first exhaust groove 44 is provided in a peripheral surface of the porous liquid suction component 4, and has a first end communicating with the first air guide groove 3051 and a second end communicating with the second air guide groove 304 and the smoke discharge hole 302. Therefore, when in an environment with low external air pressure, such as in an airplane, air on a bottom surface and the side surfaces of the porous liquid suction component 4 may be released through the cigarette holder 2, thereby avoiding liquid leakage. The porous liquid suction component 4 is spaced apart from the first end wall, a ventilation gap 45 is formed between the porous liquid suction component 4 and the first end wall, and the first exhaust groove 44 communicates with the smoke discharge hole 302 through the ventilation gap 45. Therefore, it is better ensured that an air channel is smooth and hardly blocked.

The porous liquid suction component 4 further includes a second exhaust groove 46 arranged in a manner of extending along a longitudinal direction of the porous liquid suction component 4, and the second exhaust groove 46 is located in the second side surface b of the porous liquid suction component 4. The second exhaust groove 46 has a first end communicating with the first air guide groove 3051 and a second end communicating with the cigarette holder 2. Therefore, when in an environment with low external air pressure, such as in an airplane, air on the second side surface b of the porous liquid suction component 4 may also be released through the cigarette holder 2. It can be understood that the first side surface a of the porous liquid suction component 4 and the second side surface b of the porous liquid suction component 4 may be flat surfaces, arc surfaces, or curved surfaces and are not specifically limited herein. The porous liquid suction component 4 may be made of a material such as fibers, porous ceramics, or porous foams.

The first atomization assembly 5 includes a first fixing tube 51, a first liquid guide tube 52, a first heating element 53, and a second heating element 54, where the first fixing tube 51 is inserted into the first atomizing cavity 41. The first liquid guide tube 52 is inserted into the first fixing tube 51 and configured to adsorb atomizing liquid in the porous liquid suction component 4. The first heating element 53 and the second heating element 54 are both located in the first liquid guide tube 52 and are located at different positions in an axial direction of the first liquid guide tube 52, respectively. It can be understood that it is only required that the first heating element 53 and the second heating element 54 are located at different positions in the first atomizing cavity 41 and can atomize atomizing liquid in the first atomizing cavity 41, and a structure of the first atomization assembly 5 is not specifically limited herein.

The second atomization assembly 6 includes a second fixing tube 61, a second liquid guide tube 62, and a third heating element 63, where the second fixing tube 61 is inserted into the second atomizing cavity 42. The second liquid guide tube 62 is inserted into the second fixing tube 61 and configured to adsorb the atomizing liquid in the porous liquid suction component 4. The third heating element 63 is located in the second liquid guide tube 62 and configured to atomize atomizing liquid in the second liquid guide tube 62. A sum of a resistance of the first heating element 53 and a resistance of the second heating element 54 is greater than a resistance of the third heating element 63. It can be understood that it is only required that the third heating element 63 is located in the second atomizing cavity 42 and can atomize atomizing liquid in the second atomizing cavity 42, and a structure of the second atomization assembly 6 is not specifically limited herein.

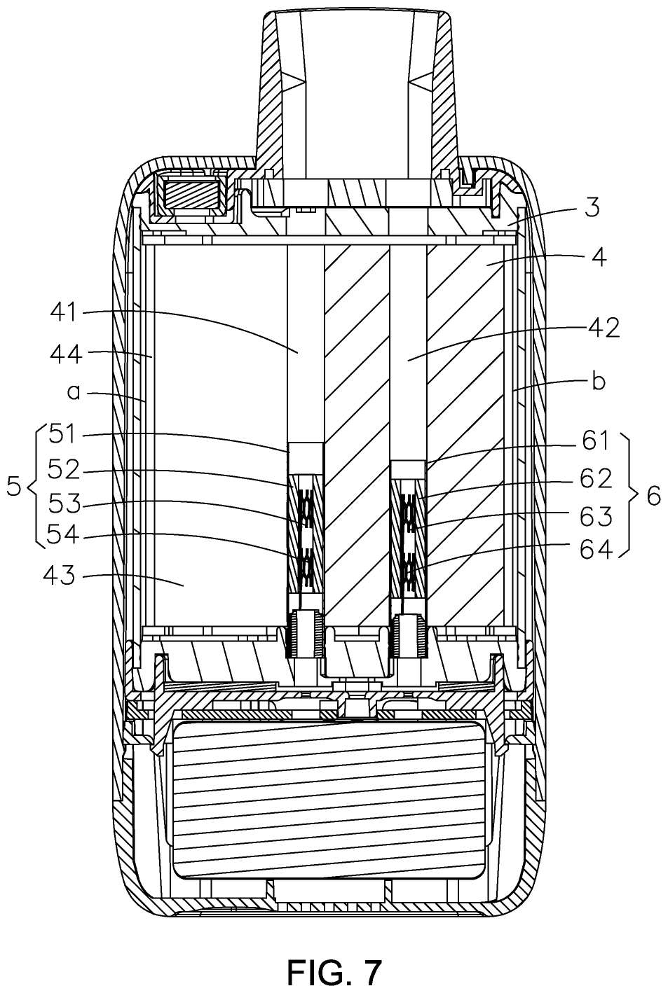

As shown in FIG. 7, in another embodiment, the second atomization assembly 6 further includes a fourth heating element 64, where the third heating element 63 and the fourth heating element 64 are located at different positions in an axial direction of the second liquid guide tube 62, and the sum of the resistance of the first heating element 53 and the resistance of the second heating element 54 is greater than a sum of the resistance of the third heating element 63 and a resistance of the fourth heating element 64. Certainly, the resistances of the heating elements may be selected as needed and are not specifically limited herein. The first fixing tube 51 and the second fixing tube 61 may be fiberglass tubes or metal tubes, the first liquid guide tube 52 and the second liquid guide tube 62 may be cotton tubes or ceramic tubes, and the first heating element 53, the second heating element 54, the third heating element 63, and the fourth heating element 64 may be heating wires or heating nets, which may be selected as needed and are not specifically limited herein.

Referring to FIG. 2 and FIG. 3, a distance between the first atomization assembly 5 and a geometric center of the porous liquid suction component 4 is smaller than a distance between the second atomization assembly 6 and the geometric center of the porous liquid suction component 4, that is, the first atomization assembly 5 is closer to the geometric center of the porous liquid suction component 4 than the second atomization assembly 6. Therefore, when the first atomization assembly 5 needs to be replenished with atomizing liquid, the atomizing liquid in the porous liquid suction component 4 is prone to flowing into the first atomization assembly 5, thus better avoiding the problem of insufficient liquid supply caused by the first heating element 53 and the second heating element 54 consuming the atomizing liquid too fast.

The lamp panel 7 is arranged in a manner of extending along the transverse direction of the first accommodating cavity 13 and is located on one side of the liquid storage component 3 that faces away from the cigarette holder 2. The lamp panel 7 is configured to fix the light source 8, such that the light source 8 is arranged at a preset position of the first accommodating cavity 13. Preferably, the lamp panel 7 is arranged on the limit steps 121, thereby enhancing the reliability of fixation and avoiding the movement during vibration.

The light source 8 is mounted on a surface of the lamp panel 7 that faces to the liquid storage component 3, and is configured to emit light to the light-transmitting area 14. The light source includes a first lamp bead 81, a second lamp bead 82, and a third lamp bead 83, where a first end of the lamp panel 7 is arranged opposite to a second end of the lamp panel 7, the first lamp bead 81 is located at the first end of the lamp panel 7, the second lamp bead 82 is located at the second end of the lamp panel 7, and the third lamp bead 83 is located on a perpendicular bisector of a connecting line of the first lamp bead 81 and the second lamp bead 82. Therefore, when the first lamp bead 81, the second lamp bead 82, and the third lamp bead 83 emit light, three-dimensional and relatively uniform light is formed. The light emitted from the light-transmitting area 14 is easily noticed by the user, such that the electronic cigarette is more easily found in the dark environment.

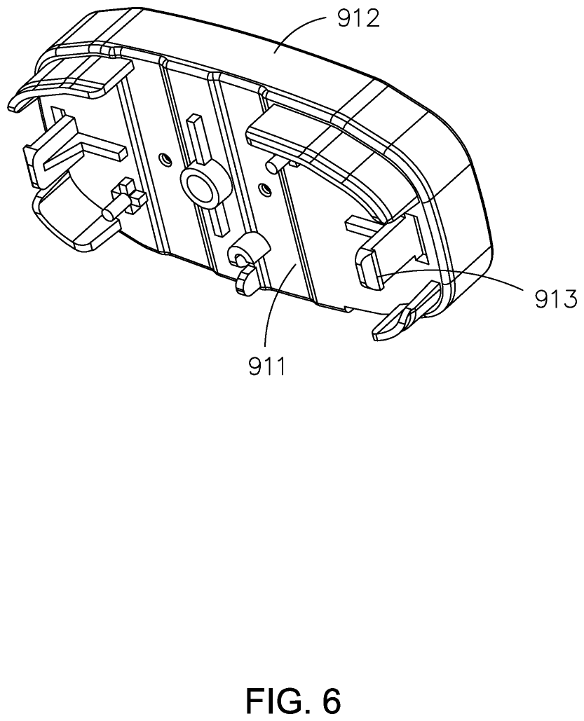

Referring to FIG. 2 and FIG. 6, the electronic cigarette further includes a fixing bracket 91, where the fixing bracket 91 has a first end detachably connected to the elastic sealing base 33 and the accommodating tube 31 of the liquid storage component 3 and a second end fastened and connected to the bottom cover 12. The lamp panel 7 is located in a space formed by the bottom cover 12 and the fixing bracket 91, making it compact in structure and easy to assemble. The fixing bracket 91 includes a base plate part 911, where the base plate part 911 is arranged in a manner of extending along the transverse direction of the first accommodating cavity 13, and a leaked liquid adsorption cotton block 92 is arranged between the base plate part 911 and the elastic sealing base 33 to adsorb leaked atomizing liquid.

The base plate part 911 extends towards the liquid storage component 3 to form a connecting sleeve part 912, and the connecting sleeve part 912 is connected to the liquid storage component 3 in a sleeving manner. The limit bulges 122 abut against the base plate part 911, such that reliable connection is implemented, the assembly is facilitated, and the production efficiency is improved. The base plate part 911 extends in a direction where the fastening bulges 123 are located to form fastening arm parts 913, and the fastening arm parts 913 penetrate through the lamp panel 7 and are fastened and connected to the fastening bulges 123. Therefore, the lamp panel 7 does not require additional fixing components to fix, reliable fixation is implemented, and the production process is simplified.

The electronic cigarette in this embodiment further includes a battery 93, an airflow sensor 94, and a controller 95, where the battery 93 is electrically connected to the controller 95 and configured to provide electrical energy. The airflow sensor 94 is located in the first accommodating groove 221 and communicates with the smoking part 21 through the second accommodating groove 306 and the third accommodating groove 308, such that the sensitivity of smoking may be improved by making the airflow sensor get close to the cigarette holder 2. The controller 95 is electrically connected to the airflow sensor 94. When the user smokes at the cigarette holder 2, the airflow sensor 94 is triggered and sends a trigger signal to the controller 95, and the controller 95 controls at least one of the first heating element 53, the second heating element 54, and the third heating element 63 to generate heat based on the trigger signal, so as to atomize the atomizing liquid in the porous liquid suction component 4. In this embodiment, upon receiving the trigger signal, the controller 95 controls the first heating element 53, the second heating element 54, and the third heating element 63 to generate heat simultaneously, so as to generate a large smoke. It can be understood that a control mode of the controller may be selected as needed and is not specifically limited herein.

In summary, according to the present disclosure, the porous liquid suction component 4 is provided with the first atomizing cavity 41 and the second atomizing cavity 42, the distance between the first atomizing cavity 41 and the first side surface a of the porous liquid suction component 4 is greater than the distance between the second atomizing cavity 42 and the second side surface b of the porous liquid suction component 4, and the first side surface a of the porous liquid suction component 4 is arranged opposite to the second side surface b of the porous liquid suction component 4. The first atomization assembly 5 includes a first heating element 53 and a second heating element 54 located at different positions in the first atomizing cavity 41, respectively. The second atomization assembly 6 includes a third heating element 63 located in the second atomizing cavity 42. Therefore, through the ingenious matching arrangement, sufficient atomizing liquid is provided around the first atomization assembly 5 and the second atomization assembly 6, such that sufficient liquid supply is ensured during operation, and the problem of dry burning caused by insufficient liquid supply is avoided.

It is obvious for those skilled in the art that the present disclosure is not limited to the details of the above exemplary embodiments and can be implemented in other specific forms without departing from the spirit or basic features of the present disclosure. Therefore, from any point of view, the embodiments should be regarded as exemplary and non-restrictive. The scope of the present disclosure is limited by the appended claims rather than the above description. Therefore, it is intended to include all changes falling within the meaning and scope of the same elements of the claims in the present disclosure. Any reference numerals in the claims shall not be regarded as limiting the claims involved.

In addition, it should be understood that although this specification is described in accordance with the embodiments, not every embodiment only contains one independent technical solution. Such description of the specification is only for the sake of clarity. Those skilled in the art should take the specification as a whole, and the technical solutions in the embodiments may also be appropriately combined to form other embodiments understandable for those skilled in the art.

What is claimed is:

1. An electronic cigarette, comprising a housing, a cigarette holder, a liquid storage component, a porous liquid suction component, a first atomization assembly, and a second atomization assembly, wherein the housing is provided with a first accommodating cavity, and the cigarette holder is connected to the housing; the liquid storage component is located in the first accommodating cavity, and a second accommodating cavity is provided in the liquid storage component; the porous liquid suction component is located in the second accommodating cavity and provided with a first atomizing cavity and a second atomizing cavity that both communicate with the cigarette holder, and the first atomizing cavity is arranged in parallel to the second atomizing cavity;
a distance between the first atomizing cavity and a first side surface of the porous liquid suction component is greater than a distance between the second atomizing cavity and a second side surface of the porous liquid suction component, and the first side surface of the porous liquid suction component is arranged opposite to the second side surface of the porous liquid suction component; the first atomization assembly comprises a first heating element and a second heating element located at different positions in the first atomizing cavity, respectively; and the second atomization assembly comprises a third heating element located in the second atomizing cavity.

2. The electronic cigarette according to claim 1, wherein a distance between the first atomization assembly and a geometric center of the porous liquid suction component is smaller than a distance between the second atomization assembly and the geometric center of the porous liquid suction component.

3. The electronic cigarette according to claim 1, wherein the porous liquid suction component is further provided with an exhaust kerf, and the exhaust kerf is located between the first side surface of the porous liquid suction component and the first atomizing cavity and communicates with the first side surface of the porous liquid suction component and the first atomizing cavity.

4. The electronic cigarette according to claim 1, wherein the second accommodating cavity comprises a first end wall and a second end wall, the first end wall is located between the cigarette holder and the second end wall, and smoke discharge holes communicating with the cigarette holder are provided in the first end wall and communicate with the first atomizing cavity and the second atomizing cavity; and a first air guide groove is provided in a surface of the second end wall that faces the porous liquid suction component, a first exhaust groove is provided in a peripheral surface of the porous liquid suction component, and the first exhaust groove has a first end communicating with the first air guide groove and a second end communicating with the smoke discharge holes.

5. The electronic cigarette according to claim 4, wherein the porous liquid suction component is spaced apart from the first end wall, a ventilation gap is formed between the porous liquid suction component and the first end wall, and the first exhaust groove communicates with the smoke discharge holes through the ventilation gap.

6. The electronic cigarette according to claim 4, wherein the first end wall is provided with an air guide hole and a second air guide groove, and the air guide hole has a first end communicating with the cigarette holder and a second end communicating with the second air guide groove; and the second air guide groove is located in a surface of the first end wall that faces the porous liquid suction component and communicates with the first exhaust groove.

7. The electronic cigarette according to claim 4, wherein the porous liquid suction component further comprises a second exhaust groove arranged in a manner of extending along a longitudinal direction of the porous liquid suction component, and the second exhaust groove is located in the second side surface of the porous liquid suction component; and the second exhaust groove has a first end communicating with the first air guide groove and a second end communicating with the cigarette holder.

8. The electronic cigarette according to claim 1, further comprising an airflow sensor, wherein the cigarette holder comprises a smoking part and a connecting plate part connected to the smoking part, and the smoking part has a first end located outside the housing and a second end penetrating through an end wall of the housing and extending into the first accommodating cavity; the connecting plate part is located in the first accommodating cavity and arranged in a manner of extending along a transverse direction of the first accommodating cavity, a first accommodating groove is provided in a surface of the connecting plate part that is connected to the smoking part, the airflow sensor is located in the first accommodating groove and communicates with the smoking part, and the liquid storage component and the end wall of the housing are clamped on the connecting plate part.

9. The electronic cigarette according to claim 8, wherein a second accommodating groove is provided in a surface of the liquid storage component that faces the connecting plate part, a groove wall of the first accommodating groove extends into the second accommodating groove, a groove wall of the second accommodating groove is elastically sleeved with and connected to the groove wall of the first accommodating groove, and the airflow sensor communicates with the smoking part through the second accommodating groove.

10. The electronic cigarette according to claim 9, wherein the liquid storage component comprises an accommodating tube, an elastic sealing top cover, and an elastic sealing base, the accommodating tube is located in the first accommodating cavity, the elastic sealing top cover is arranged at a first end of the accommodating tube in a covering manner, the elastic sealing base is arranged at a second end of the accommodating tube in a covering manner, and the second accommodating cavity is located in a space formed by the accommodating tube, the elastic sealing top cover, and the elastic sealing base; a third accommodating groove is provided in a surface of the elastic sealing top cover that faces the connecting plate part, and communicates with the first atomizing cavity and the second atomizing cavity, and a condensate adsorption sheet is accommodated in the third accommodating groove; and the smoking part communicates with the third accommodating groove, and the second accommodating groove is located in the surface of the elastic sealing top cover that faces the connecting plate part, and communicates with the smoking part through the third accommodating groove.

11. The electronic cigarette according to claim 1, further comprising a lamp panel and a light source, wherein a light-transmitting area is arranged at a cavity wall of the first accommodating cavity, and the lamp panel is arranged in a manner of extending along the transverse direction of the first accommodating cavity and located on one side of the liquid storage component that faces away from the cigarette holder; and the light source is mounted on a surface of the lamp panel that faces the liquid storage component, and is configured to emit light to the light-transmitting area.

12. The electronic cigarette according to claim 11, wherein an optical path transmission gap is formed between the housing and a side surface of the liquid storage component and is configured to guide at least part of the light emitted by the light source to the light-transmitting area.

13. The electronic cigarette according to claim 12, further comprising a light guide component at least partially located at the optical path transmission gap.

14. The electronic cigarette according to claim 11, wherein the light source comprises a first lamp bead, a second lamp bead, and a third lamp bead, a first end of the lamp panel is arranged opposite to a second end of the lamp panel, the first lamp bead is located at the first end of the lamp panel, the second lamp bead is located at the second end of the lamp panel, and the third lamp bead is located on a perpendicular bisector of a connecting line of the first lamp bead and the second lamp bead.

15. The electronic cigarette according to claim 11, wherein limit steps are arranged at the cavity wall of the first accommodating cavity, and the lamp panel is arranged on the limit steps.

16. The electronic cigarette according to claim 15, wherein the housing comprises an outer sleeve and a bottom cover, a first end of the bottom cover is detachably inserted into the outer sleeve and connected to the outer sleeve, the limit steps are formed at an end surface of the first end of the bottom cover, and a second end of the bottom cover is located outside the outer sleeve; and the liquid storage component is located in the outer sleeve.

17. The electronic cigarette according to claim 16, further comprising a fixing bracket, wherein the fixing bracket has a first end detachably connected to the liquid storage component and a second end fastened and connected to the bottom cover; and the lamp panel is located in a space formed by the bottom cover and the fixing bracket.

18. The electronic cigarette according to claim 17, wherein fastening bulges are arranged at an inner wall of the bottom cover, and limit bulges are arranged at the end surface of the first end of the bottom cover; the fixing bracket comprises a base plate part arranged in a manner of extending along the transverse direction of the first accommodating cavity, and the limit bulges abut against the base plate part; the base plate part extends towards the liquid storage component to form a connecting sleeve part, and the connecting sleeve part is connected to the liquid storage component in a sleeving manner; and the base plate part extends in a direction where the fastening bulges are located to form fastening arm parts, and the fastening arm parts penetrate through the lamp panel and are fastened and connected to the fastening bulges.
